(19) United States
(12) Patent Application Publication
(10) Pub. No.: US 2016/0158785 A1
(43) Pub. Date: Jun. 9, 2016

(54) SPRAY SYSTEM AND USE METHOD THEREOF

(71) Applicants: BOE TECHNOLOGY GROUP CO., LTD., Beijing (CN); HEFEI XINSHENG OPTOELECTRONICS TECHNOLOGY CO., LTD., Hefei City (CN)

(72) Inventors: Wei ZHOU, Beijing (CN); Yongdong ZHAO, Beijing (CN); Liming XU, Beijing (CN); Jintao XIE, Beijing (CN); Lin HUANG, Beijing (CN); Liang YAO, Beijing (CN)

(21) Appl. No.: 14/801,178

(22) Filed: Jul. 16, 2015

(30) Foreign Application Priority Data
Dec. 5, 2014 (CN) 201410735183.1

(51) Int. Cl. B05B 15/02; B05D 1/02; B05B 9/03

(52) U.S. Cl. CPC B05B 15/025; B05B 9/035; B05D 1/02

(57) ABSTRACT

A spray system and a use method thereof are provided. The spray system includes: a plurality of cascaded spray members having a plurality of spray heads, a spray liquid supply system, a spray liquid recovery system and a control system, wherein the control system is configured to control the spray liquid supply system to provide a spray liquid for substrates to be sprayed for spraying in the working stage of the spray system and control the spray liquid recovery system to recycle the spray liquid after the spraying process is over; a cleaning solution supply system configured to provide a cleaning solution for the spray heads of the spray members for cleaning under the control of the control system in the cleaning stage; and a liquid waste disposal system configured to discharge liquid waste after cleaning under the control of the control system after the cleaning stage is over.

### TECHNICAL FIELD

Embodiments of the present disclosure relate to a spray system and a use method thereof.

### BACKGROUND

A developing apparatus and a cleaning apparatus are collectively known as a spray system. As shown in FIG. 1, a traditional spray system includes: a plurality of cascaded spray members 001 having a plurality of spray heads, a spray liquid supply system 21, a spray liquid recovery system 22 and a control system 20. The spray liquid supply system 21 includes a spray liquid supply device 100, spray liquid circulatory tanks 002 disposed below other spray members except a first spray member 001a, a spray liquid supply pipeline 1 of communicating the spray liquid supply device 100 and spray heads of a final spray member 001c, branched spray liquid supply branch pipelines 2 of communicating the spray liquid supply device 100 and the spray liquid circulatory tanks 002, spray liquid inlet pipes 3 of communicating the spray liquid circulatory tanks 002 below the spray members and spray heads of the last spray member, and power members, wherein the spray liquid circulatory tank 002 is configured to collect a spray liquid flowing out from the bottom of the spray member. The spray liquid recovery system 22 includes a spray liquid recovery device 200, a spray liquid drainage pipe 4 of which one end is disposed under the first spray member 001a and the other end is communicated with the spray liquid recovery device 200, and branched spray liquid drainage pipes 5 of communicating the spray liquid circulatory tanks 002 and the spray liquid recovery device 200. The control system is configured to control the spray liquid supply system to provide a spray liquid for substrates to be sprayed for spraying in the working stage of the spray system and control the spray liquid recovery system to recycle the spray liquid. In the working stage of the spray system, the spray liquid supply device 100 provides a spray liquid for the spray heads of the final spray member 001c through the spray liquid supply pipeline 1; subsequently, the spray liquid flows into the spray liquid circulatory tank 002 below the final spray member 001c, flows into the spray heads of the last spray member through the spray liquid inlet pipe 3 under the action of the power member, and is recycled, and finally flows into the spray heads of the first spray member 001a. In this way, the substrates in the spray members are sprayed. Moreover, after the spraying process is over, the spray liquid flows into the spray liquid recovery device 200 for discharge through the spray liquid drainage pipe 4 and the branched spray liquid drainage pipes 5.

### SUMMARY

Embodiments of the present disclosure provide a spray system and a use method thereof, which can achieve fully automatically cleaning the spray system and improve the cleaning efficiency.

The embodiments of the present disclosure provide a spray system, which includes: a plurality of cascaded spray members provided with a plurality of spray heads; a spray liquid supply system; a spray liquid recovery system; a control system configured to control the spray liquid supply system to provide a spray liquid for substrates to be sprayed for spraying in the working stage of the spray system and control the spray liquid recovery system to recycle the spray liquid after the working stage of the spray system is over; a cleaning solution supply system configured to provide a cleaning solution for the spray heads of the spray members for cleaning under the control of the control system in the cleaning stage; and a liquid waste disposal system configured to discharge liquid waste after cleaning under the control of the control system after the cleaning stage is over.

The embodiments of the present disclosure also provide a use method of the spray system, which includes: controlling the cleaning solution supply system to provide the cleaning solution for the spray heads of the spray members for cleaning in the cleaning stage; and controlling the spray liquid supply system to provide the spray liquid for the substrates to be sprayed for spraying in the working stage of the spray system.

### BRIEF DESCRIPTION OF THE DRAWINGS

FIG. 1 is a schematic structural view of a spray system;

FIG. 2 is a schematic structural view of a spray system provided by an embodiment of the present disclosure;

FIG. 3 is a schematic structural view of another spray system provided by an embodiment of the present disclosure;

FIG. 4 is a schematic structural view of yet another spray system provided by an embodiment of the present disclosure;

FIG. 5 is a functional module diagram of a spray system provided by an embodiment of the present disclosure;

FIG. 6 is a schematic structural view of a liquid level monitoring system in the spray system provided by an embodiment of the present disclosure;

FIG. 7 is a functional module diagram of a liquid level monitoring system provided by an embodiment of the present disclosure;

FIG. 8 is a flowchart of a use method of the spray system provided by the embodiment of the present disclosure.

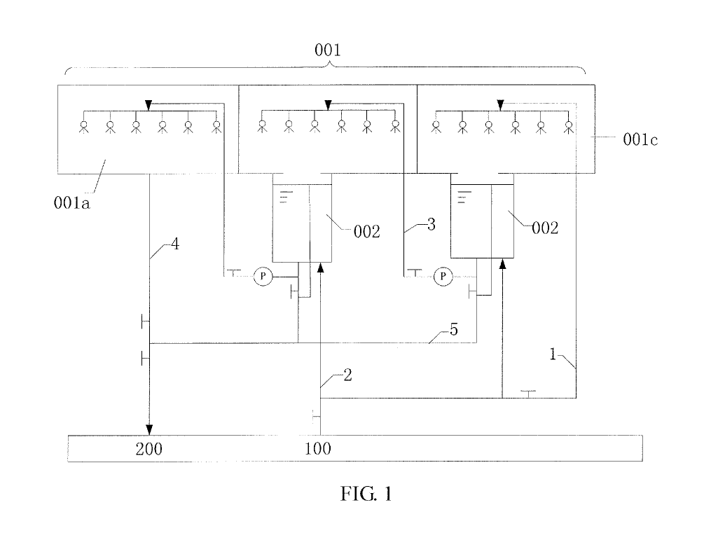

### DETAILED DESCRIPTION

Technical solutions according to the embodiments of the present disclosure will be described clearly and completely as below in conjunction with the accompanying drawings of embodiments of the present disclosure. It is apparent that the described embodiments are only a part of but not all of exemplary embodiments of the present disclosure. Based on the described embodiments of the present disclosure, various other embodiments and variants can be obtained by those of ordinary skill in the art without creative labor and those embodiments and variants shall fall into the protection scope of the present disclosure.

Unless otherwise defined, all the technical and scientific terms used herein have the same meanings as commonly understood by one of ordinary skill in the art to which the present disclosure belongs. The terms, such as “first,” “second,” or the like, which are used in the description and the claims of the present application, are not intended to indicate any sequence, amount or importance, but for distinguishing various components. Also, the terms, such as “a/an,” “one,” or the like, are not intended to limit the amount, but for indicating the existence of at lease one. The terms, such as “comprise/comprising,” “include/including,” or the like are intended to specify that the elements or the objects stated before these terms encompass the elements or the objects and equivalents thereof listed after these terms, but not preclude other elements or objects. The terms, “on,” “under,” or the like are only used to indicate relative position relationship, and when the position of the object which is described is changed, the relative position relationship may be changed accordingly.

The inventors notice that for a cleaning apparatus in the spray system, in the working stage of the cleaning apparatus, since deionized water is utilized for a long time to clean substrates in spray members, particles and organic substance, such as a small amount of photoresist, on surfaces of the cleaned substrates are gradually accumulated in pipes and spray heads of the cleaning apparatus in the recycling process. The foreign matters seriously affect the cleaning ability of the cleaning apparatus and can result in abnormal quality of the substrates. Therefore, the removal of the foreign matters in the pipes and the spray heads is important to improve the yield of products and the maintenance of equipment. The typical method for removing the foreign matters in the pipes and the spray heads of the spray system is to manually disassemble the pipes and the spray heads and remove dirt by the soak cleaning of a cleaning solution. Although the method can remove the dirt, the operation procedure is complex and the task is heavy. In addition, the wear of equipment can be caused due to frequently disassembling of the pipes and the spray heads. Similarly, the developing apparatus also present the above problems.

Therefore, it is a technical problem to be solved by those skilled in the art to clean the pipes and the spray heads of the spray system without manual disassembling and hence improve the cleaning efficiency.

Detailed description will be given below to the embodiments of the spray system and the use method thereof, provided by the embodiment of the present disclosure, with reference to the accompanying drawings.

The size and the shape of the components in the accompanying drawings in the text do not reflect the true scale of the spray system and are only intended to illustrate the content of the present disclosure.

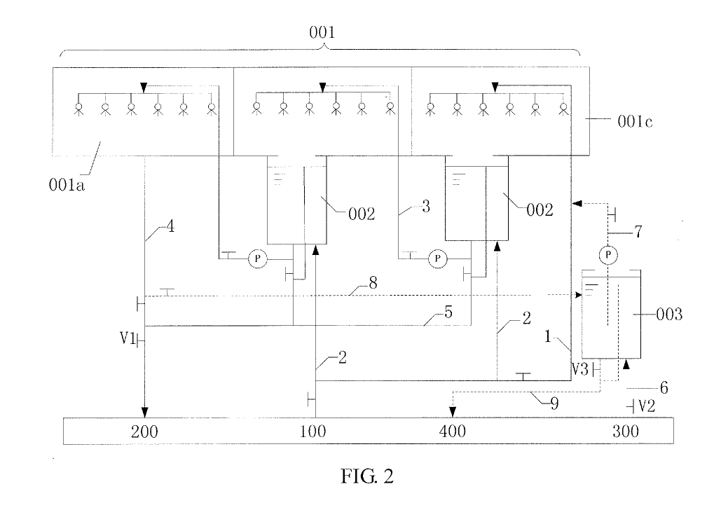

The embodiment of the present disclosure provides a spray system, as shown in FIG. 2 and FIG. 5, it includes: a plurality of cascaded spray members 001 provided with a plurality of spray heads (though only three spray members are shown in FIG. 2, more than three spray members can be provided in the present spray system, and it is also possible there are only two spray members in the spray system), a spray liquid supply system 21, a spray liquid recovery system 22 and a control system 20. The control system 20 is configured to control the spray liquid supply system 21 to provide a spray liquid for substrates to be sprayed for spraying in the working stage of the spray system and control the spray liquid recovery system 22 to recycle the spray liquid after the working stage of the spray system is over.

The spray system further includes: a cleaning solution supply system 23 configured to provide a cleaning solution for the spray heads of the spray members for cleaning under the control of the control system in the cleaning stage.

The spray system can further include a liquid waste disposal system 24 configured to discharge liquid waste after cleaning under the control of the control system after the cleaning stage is over.

In the spray system provided by the embodiment of the present disclosure, as a cleaning solution supply system 23 and a liquid waste disposal system 24 are additionally arranged in the spray system, compared with a spray system without these two additionally added system, the spray system provided by the embodiment of the present disclosure not only does not affect the function of spraying the substrates in the spray members in the working stage of the spray system but also can achieve the function of fully automatically cleaning the spray system in the self-cleaning stage, effectively remove foreign matters in pipes and spray heads of the spray system, and improve the cleaning efficiency. As the method of manual disassembly is not used, manual work and the wear of the spray system are reduced.

In an implementation, in the spray system provided by the embodiment of the present disclosure, to achieve the function of automatically or full-automatically cyclically cleaning the spray system, as shown in FIG. 2 and FIG. 5, the cleaning solution supply system 23 may include: a cleaning solution supply device 300, a cleaning solution circulatory pool 003, a supply pipeline 6 of communicating the cleaning solution supply device 300 and the cleaning solution circulatory pool 003, an inlet pipe 7 of communicating the cleaning solution circulatory pool 003 and spray heads of a final spray member 001c, a return pipeline 8 of which one end is disposed under a first spray member 001a and the other end is connected with the cleaning solution circulatory pool 003, power members P, and spray liquid circulatory tanks 002 and spray liquid inlet pipes 3 sharing the spray liquid supply system. The cleaning solution supply device is configured to transfer a cleaning solution to the cleaning solution circulatory pool 003 through the supply pipeline 6 in the cleaning stage.

The cleaning solution circulatory pool 003 is configured to transfer the cleaning solution to the spray heads of the final spray member 001c through the inlet pipe 7 under the action of the power member P in the cleaning stage, and receive the liquid waste after cleaning.

In the cleaning stage, the spray liquid circulatory tank 002 disposed below a spray member except the first spray member 001a may also be configured to transfer the cleaning solution to spray heads of the last spray member under the action of the power member through the spray liquid inlet pipe 3 communicating the spray liquid circulatory tank 002 below the spray member and the spray heads of the last spray member.

The return pipeline 8 is configured to transfer the liquid waste after cleaning to the cleaning solution circulatory pool 003.

For instance, In an implementation, to allow the spray liquid or the cleaning solution to flow up from downward in the spray system, the inlet pipe is usually provided with the power member. The power member referred herein can be a pressure pump P. As shown in FIG. 2, a pressure pump P may be disposed on the spray liquid inlet pipe 3 of communicating the spray liquid circulatory tank 002 below the spray member and the spray heads of the last spray member, so as to allow the spray liquid or the cleaning solution in the spray liquid circulatory tank 002 to flow out from the spray heads of the last spray member. A pressure pump P may also be disposed on the inlet pipe 7 of communicating the spray heads of the final spray member 001c and the cleaning solution circulatory pool 003, so as to allow the cleaning solution in the cleaning solution circulatory pool 003 to flow out from the spray heads of the final spray member 001c and flow into the spray liquid circulatory tank 002, so that the cyclic self-cleaning process can be achieved.

In an implementation, in the spray system provided by the embodiment of the present disclosure, to discharge liquid waste after the cleaning process is over, as shown in FIG. 2, the liquid waste disposal system 24 may include: a liquid waste disposal device 400 and a drainage pipe 9 of communicating the cleaning solution circulatory pool 003 and the liquid waste disposal device 400.

The drainage pipe 9 is configured to transfer the liquid waste obtained after cleaning to the liquid waste disposal device 400 after the cleaning process is over.

The liquid waste disposal device 400 is configured to perform a harmless treatment to the liquid waste.

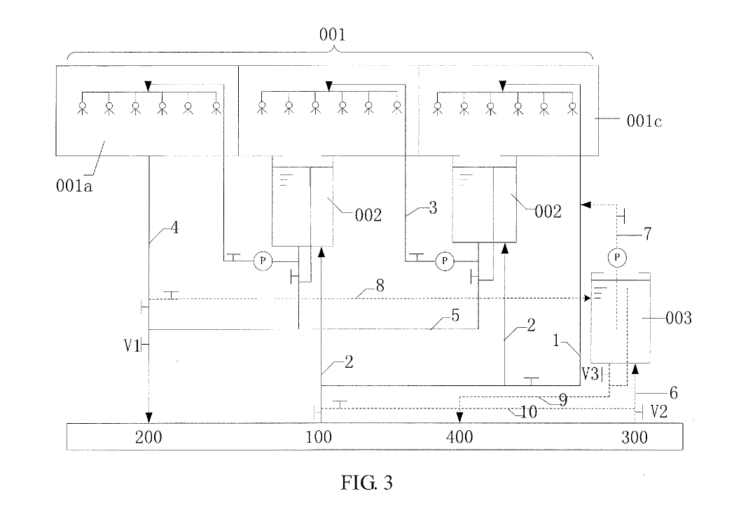

In an implementation, in the spray system provided by the embodiment of the present disclosure, to allow the spray heads of the final spray member and the spray liquid circulatory tanks to simultaneously and quickly have the cleaning solution supplied by the cleaning solution supply device in the self-cleaning stage so as to improve the self-cleaning efficiency, as shown in FIG. 3, the cleaning solution supply system 23 may further include branched supply pipes 2 of communicating the cleaning solution supply device 300 and the spray heads of the final spray member 001c, so as to allow the cleaning solution supply device 300 to directly provide the cleaning solution for the spray heads of the final spray member 001c. The cleaning solution supply system 23 may further include branched supply pipes 2 of communicating the cleaning solution supply device 300 and the spray liquid circulatory tanks 002, so as to allow the cleaning solution supply device 300 to directly provide the cleaning solution for the spray liquid circulatory tanks 002.

In the cleaning stage, the cleaning solution supply device 300 may also be configured to transfer the cleaning solution to the spray heads of the final spray member 001c through the straight supply pipeline 10 and transfer the cleaning solution to the spray liquid circulatory tanks 002 through the branched supply pipes 2.

In an implementation, in the spray system provided by the embodiment of the present disclosure, to allow the cleaning solution in the first spray member and the spray liquid circulatory tanks to simultaneously and quickly flow into the liquid waste disposal device 400 in the self-cleaning stage, drainage pipes 11 may be configured to allow the liquid waste collected by the spray liquid circulatory tanks 002 directly into the liquid waste disposal device 400.

A straight drainage pipe 11 is configured to transfer the liquid waste under the first spray member 001a to the liquid waste disposal device 400 after the cleaning stage is over.

Branched drainage pipes 11 may be configured to transfer the liquid waste collected by the spray liquid circulatory tanks 002 to the liquid waste disposal device 400.

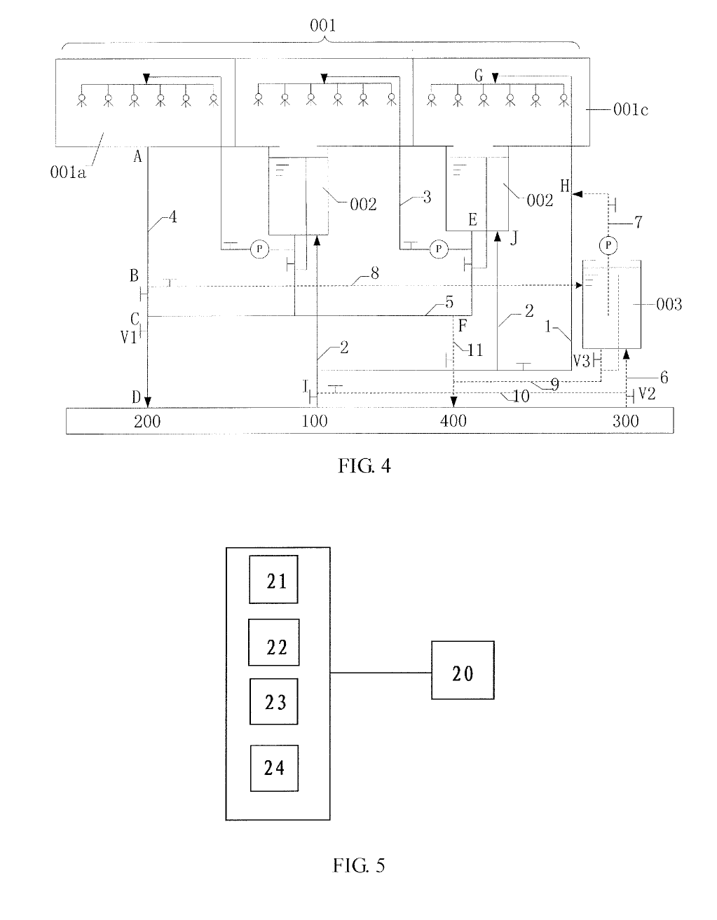

In an implementation, in the spray system provided by the embodiment of the present disclosure, to save pipes in the spray system, as shown in FIG. 4, the return pipeline 8 of communicating the cleaning solution circulatory pool 003 and the bottom of the first spray member 001a and the spray liquid drainage pipe 4 of communicating the bottom of the first spray member 001a and the spray liquid recovery device 200 in the spray liquid recovery system 22 may share partial pipe AB; and/or the spray liquid drainage pipe 4 of communicating the bottom of the first spray member 001a and the spray liquid recovery device 200 and the straight drainage pipe 11 of communicating the bottom of the first spray member 001a and the liquid waste disposal device 400 may share partial pipe AC; and/or the branched spray liquid drainage pipe 5 of communicating the spray liquid circulatory tank 002 and the spray liquid recovery device 200 and the branched drainage pipe 11 of communicating the spray liquid circulatory tank 002 and the liquid waste disposal device 400 may share partial pipe EF; and/or the inlet pipe 7 of communicating the spray heads of the final spray member 001c and the cleaning solution circulatory pool 003 and the spray liquid supply pipeline 1 of communicating the spray heads of the final spray member 001c and the spray liquid supply device 100 may share partial pipe GH; and/or the straight supply pipeline 10 of communicating the spray heads of the final spray member 001c and the cleaning solution supply device 300 and the spray liquid supply pipeline 1 of communicating the spray heads of the final spray member 001c and the spray liquid supply device 100 may share partial pipe GI; and/or the branched supply pipeline 10 of communicating the spray liquid circulatory tank 002 and the cleaning solution supply device 300 and the branched spray liquid supply pipeline 2 of communicating the spray liquid circulatory tank 002 and the spray liquid supply device 100 may share partial pipe IJ.

In an implementation, in the spray system provided by the embodiment of the present disclosure, to control the flow direction of the spray liquid and the cleaning solution in the spray system, control valves Vx may be respectively disposed on the return pipeline, the supply pipeline, the drainage pipe, the inlet pipe, the straight supply pipeline, the branched supply pipelines, the straight drainage pipe, the branched drainage pipes, the spray liquid inlet pipes, the spray liquid drainage pipe, the branched spray liquid drainage pipes, the spray liquid supply pipeline and the branched spray liquid supply pipelines, wherein x is 1 to n. As shown in FIG. 4, a control valve V1 is disposed on the spray liquid drainage pipe 4 of communicating the bottom of the first spray member 001a and the spray liquid recovery device 200, which can control whether to allow liquid flowing out from the bottom of the first spray member 001a to enter the spray liquid recovery device 200, or not.

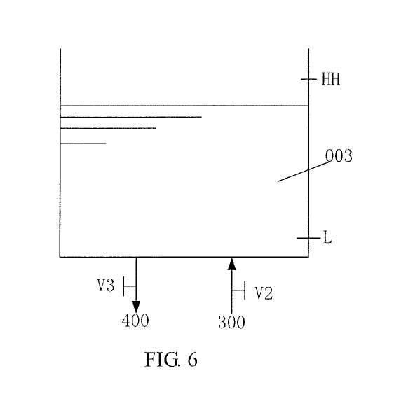

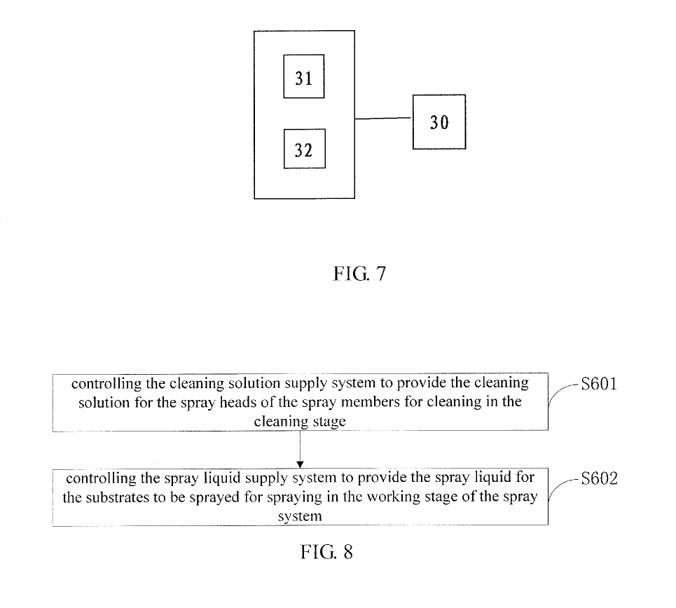

In an implementation, in the spray system provided by the embodiment of the present disclosure, to monitor the liquid level of the cleaning solution in the cleaning solution circulatory pool 003 so as to supplement or discharge the cleaning solution in tome, as shown in FIG. 6 and FIG. 7, the spray system may further include a liquid level monitoring system 30 disposed in the cleaning solution circulatory pool 003. The liquid level monitoring system 30 is configured to monitor the liquid level of the cleaning solution in the cleaning solution circulatory pool 003. When the liquid level of the cleaning solution is lower than a preset liquid level (height) L, a control valve V2 on the supply pipeline 6 of communicating the cleaning solution circulatory pool 003 and the cleaning solution supply device 300 is automatically switched on to supplement the cleaning solution. When the liquid level of the cleaning solution is higher than another preset liquid level HH, a control valve V3 on the drainage pipe 9 of communicating the cleaning solution circulatory pool 003 and the liquid waste disposal device 400 is automatically switched on to discharge the cleaning solution. The liquid level monitoring system 30 may include one or more liquid level sensors (31, 32), such as two sensors, one end of the liquid level sensors (31, 32) is located in the cleaning solution and the other end of the liquid level sensors (31, 32) is connected to control valve V2 and/or V3, as shown in FIG. 6 and FIG. 7.

In an implementation, in the spray system provided by the embodiment of the present disclosure, the spray liquid may be developer solution or deionized water. If the spray system is a developing apparatus, the developer solution is selected as the spray liquid. If the spray system is a cleaning apparatus, the deionized water is selected as the spray liquid.

Based on the same invention concept, the embodiment of the present disclosure also provides a method of using the spray system provided by the embodiment of the present disclosure. As the principle of the method to solve the problem is similar to that of the spray system, the implementations of the method may refer to the implementations of the spray system. Repeated description will be omitted.

In an implementation, as shown in FIG. 8, the use method of the spray system provided by the embodiment of the present disclosure includes the following steps.

S601: controlling the cleaning solution supply system to provide the cleaning solution for the spray heads of the spray members for cleaning in the cleaning stage.

In an implementation, in the cleaning stage, at first, the cleaning solution is provided to the cleaning solution circulatory pool by the control system controlling the cleaning solution supply system; the cleaning solution in the cleaning solution circulatory pool flows into the spray heads of the final spray member through the inlet pipe under the action of the power member, flows into the spray liquid circulatory tank below the final spray member, flows into the spray heads of the last spray member through the spray liquid inlet pipe under the action of the power member, which is recycled, and finally flows into the spray heads of the first spray member. In this way, the spray heads of the spray members are cleaned; the cleaning solution returns to the cleaning solution circulatory pool through the return pipeline; the above steps are repeated; and hence the spray heads of the spray members are fully automatically and cyclically cleaned in a closed way. Moreover, after the cleaning process is over, the control system controls the liquid waste to flow into the liquid waste disposal device and discharge it.

S602: controlling the spray liquid supply system to provide the spray liquid for the substrates to be sprayed for spraying in the working stage of the spray system.

In the working stage of the spray system, at first, the spray liquid is provided for the spray heads of the final spray member by the control system controlling the spray liquid supply system; then, the spray liquid flows into the spray liquid circulatory tank below the final spray member, flows into the spray heads of the last spray member through the spray liquid inlet pipe under the action of the power member, which is recycled, and finally flows into the spray heads of the first spray member; and hence the substrates in the spray members are sprayed. Moreover, after the spraying process is over, the control system controls the spray liquid to flow into the spray liquid recovery device and discharge it. The power member can be a pressure pump, for example.

Detailed description will be given below to the use method of the spray system provided by the embodiment of the present disclosure with reference to an example. The use method may include two modes, for example.

1. Self-cleaning mode: as shown in FIG. 4, at first, the cleaning solution is provided for the cleaning solution circulatory pool 003 by the control system 20 controlling the cleaning solution supply device 300, the cleaning solution in the cleaning solution circulatory pool 003 flows into the spray heads of the final spray member 001c through the inlet pipe 7 under the action of a pressure pump P, flows into the spray liquid circulatory tank 002 below the final spray member 001c, flows into the spray heads of the last spray member through the spray liquid inlet pipe 3 under the action of the pressure pump P, which is recycled, and finally flows into the spray heads of the first spray member 001a; thus the spray heads of the spray members are cleaned. The cleaning solution returns to the cleaning solution circulatory pool 003 through the return pipeline 8, thus the spray heads of the spray members are fully automatically and cyclically cleaned in a closed way. Moreover, after the cleaning process is over, the control system 20 controls the liquid waste to flow into the liquid waste disposal device 400 to discharge it through the drainage pipe 9.

The fully automatic cleaning process of the spray system provided by the embodiment of the present disclosure is completed through the above steps provided by the example.

2. Working mode of the spray system: as shown in FIG. 4, at first, the spray liquid is directly provided for the spray heads of the final spray member 001c by the control system 20 controlling the spray liquid supply device 100 through the spray liquid supply pipeline 1; then, the spray liquid flows into the spray liquid circulatory tank 002 below the final spray member 001c, flows into the spray heads of the last spray member through the spray liquid inlet pipe 3 under the action of the pressure pump P, which is recycled, and finally flows into the spray heads of the first spray member 001a; and hence the substrates in the spray members are sprayed. Moreover, after the spraying process is over, the control system 20 controls the spray liquid to flow into the spray liquid recovery device 200 to discharge it through the spray liquid drainage pipe 4 and the branched spray liquid drainage pipes 5.

The use process of the spray system provided by the embodiment of the present disclosure is completed through the above steps provided by the example.

In the spray system and the use method thereof, provided by the embodiments of the present disclosure, the spray system includes: a plurality of cascaded spray members provided with a plurality of spray heads, a spray liquid supply system 21, a spray liquid recovery system 22 and the control system 20, wherein the control system 20 is configured to control the spray liquid supply system to provide the spray liquid for the substrates to be sprayed for spraying in the working stage of the spray system and control the spray liquid recovery system 22 to recycle the spray liquid after the spraying process is over. The spray system further includes: a cleaning solution supply system 23 configured to provide a cleaning solution for the spray heads of the spray members for cleaning under the control of the control system 20 in the cleaning stage; and a liquid waste disposal system 24 configured to discharge the liquid waste obtained after cleaning under the control of the control system 20 after the cleaning stage is over. Compared with the conventional spray system, the spray system provided by the embodiment of the present disclosure is additionally provided with a cleaning solution supply system 23 and a liquid waste disposal system 24, which does not affect the function of spraying the substrates in the spray members in the working stage of the spray system and can achieve the function of fully automatically cleaning the spray system, effectively remove foreign matters in the pipes and the spray heads of the spray system, and improve the cleaning efficiency. As the method of manual disassembly is not used, manual work is reduced and the wear to the spray system is reduced.

It is understood that the above embodiments or implementations are merely exemplary implementations used only for the purpose of explaining the principle of the present disclosure, but the invention is not limited thereto. For a person of ordinary skill in the art, a variety of variants and modifications can be made without departing from the spirit and essence of the disclosure. These variants and modifications shall fall in the scope of the present invention.

This application claims the priority of the Chinese patent application No. 201410735183.1, entitled ‘a spray system and a use method thereof’, filed on Dec. 5, 2014, which is incorporated herein in its entirety by reference.

What is claimed is:

1. A spray system, comprising:
a plurality of cascaded spray members provided with a plurality of spray heads;
a spray liquid supply system;
a spray liquid recovery system;
a control system configured to control the spray liquid supply system to provide a spray liquid for substrates to be sprayed for spraying in the working stage of the spray system and control the spray liquid recovery system to recycle the spray liquid after the working stage of the spray system is over;
a cleaning solution supply system configured to provide a cleaning solution for the spray heads of the spray members for cleaning under the control of the control system in the cleaning stage; and
a liquid waste disposal system configured to discharge liquid waste after cleaning under the control of the control system after the cleaning stage is over.

2. The spray system according to claim 1, wherein the cleaning solution supply system includes: a cleaning solution supply device, a cleaning solution circulatory pool, a supply pipeline of communicating the cleaning solution supply device and the cleaning solution circulatory pool, an inlet pipe of communicating the cleaning solution circulatory pool and spray heads of a final spray member, a return pipeline of which one end is disposed under a first spray member and the other end is connected with the cleaning solution circulatory pool, power members, and spray liquid circulatory tanks and spray liquid inlet pipes sharing the spray liquid supply system.

3. The spray system according to claim 2, wherein
the cleaning solution supply device is configured to transfer the cleaning solution to the cleaning solution circulatory pool through the supply pipeline in the cleaning stage;
the cleaning solution circulatory pool is configured to transfer the cleaning solution to the spray heads of the final spray member through the supply pipeline under the action of the power member in the cleaning stage, and receive the liquid waste after cleaning;
in the cleaning stage, the spray liquid circulatory tanks below the spray members except the first spray member are also configured to transfer the cleaning solution to spray heads of the last spray member under the action of the power member through the spray liquid inlet pipe of communicating the spray liquid circulatory tank below the spray member and the spray heads of the last spray member; and
the return pipeline is configured to transfer the liquid waste after cleaning to the cleaning solution circulatory pool.

4. The spray system according to claim 3, wherein the cleaning solution supply system further includes a liquid level monitoring system disposed in the cleaning solution circulatory pool and configured to monitor a liquid level of the cleaning solution in the cleaning solution circulatory pool.

5. The spray system according to claim 3, wherein the cleaning solution supply system further includes: a straight supply pipeline of communicating the cleaning solution supply device and the spray heads of the final spray member, and branched supply pipelines of communicating the cleaning solution supply device and the spray liquid circulatory tanks, wherein, in the cleaning stage, the cleaning solution supply device is also configured to transfer the cleaning solution to the spray heads of the final spray member through the straight supply pipeline; and transfer the cleaning solution to the spray liquid circulatory tanks through the branched supply pipelines.

6. The spray system according to claim 5, wherein the liquid waste disposal system includes: a liquid waste disposal device and a drainage pipe of communicating the cleaning solution circulatory pool and the liquid waste disposal device, wherein
the drainage pipe is configured to transfer the liquid waste after cleaning to the liquid waste disposal device after the cleaning process is over; and
the liquid waste disposal device is configured to perform a harmless treatment to the liquid waste.

7. The spray system according to claim 5, wherein the liquid waste disposal system further includes: a straight drainage pipe of which one end is disposed under the first spray member and the other end is communicated with the liquid waste disposal device, and branched drainage pipes of communicating the spray liquid circulatory tanks and the liquid waste disposal device,
wherein the straight drainage pipe is configured to transfer liquid waste below the first spray member to the liquid waste disposal device after the cleaning stage is over; and
the branched drainage pipes are configured to transfer liquid waste collected by the spray liquid circulatory tanks to the liquid waste disposal device after the cleaning stage is over.

8. The spray system according to claim 7, wherein the straight drainage pipe and a spray liquid drainage pipe in the spray liquid recovery system share partial pipe; and/or
the branched drainage pipes and branched spray liquid drainage pipes in the spray liquid recovery system share partial pipe; and/or
the return pipeline and the spray liquid drainage pipe in the spray liquid recovery system share partial pipe; and/or
the inlet pipe and a spray liquid supply pipeline in the spray liquid supply system share partial pipe; and/or
the straight supply pipeline and the spray liquid supply pipeline in the spray liquid supply system share partial pipe; and/or
the branched supply pipelines and branched spray liquid supply pipelines in the spray liquid supply system share partial pipe.

9. The spray system according to claim 8, wherein control valves are respectively disposed on the return pipeline, the supply pipeline, the drainage pipe, the inlet pipe, the straight supply pipeline, the branched supply pipelines, the straight drainage pipe, the branched drainage pipes, the spray liquid inlet pipes, the spray liquid drainage pipe, the branched spray liquid drainage pipes, the spray liquid supply pipeline and the branched spray liquid supply pipelines.

10. The spray system according to claim 4, wherein the liquid level monitoring system comprises at least one liquid level sensor, one end of the at least one liquid level sensor is located in the cleaning solution, and the other end is connected with a valve on the inlet pipeline under the cleaning solution circulatory pool.

11. The spray system according to claim 10, wherein the other end of the at least one liquid level sensor is connected with a valve on the outlet pipeline under the cleaning solution circulatory pool.

12. The spray system according to claim 2, wherein the power member is a pressure pump.

13. A method of using the spray system according to claim 1, comprising:
controlling the cleaning solution supply system to provide the cleaning solution for the spray heads of the spray members for cleaning in the cleaning stage; and
controlling the spray liquid supply system to provide the spray liquid for the substrates to be sprayed for spraying in the working stage of the spray system.

14. The method according to claim 13, further comprising:
in the cleaning stage, providing the cleaning solution to the cleaning solution circulatory pool by the control system controlling the cleaning solution supply system, the cleaning solution in the cleaning solution circulatory pool flows into the spray heads of the final spray member through the inlet pipe under the action of the power member, flows into the spray liquid circulatory tank below the final spray member, flows into the spray heads of the last spray member through the spray liquid inlet pipe under the action of the power member, and flows into the spray heads of the first spray member;
returning the cleaning solution to the cleaning solution circulatory pool through the return pipeline;
repeating the above steps; and
after the cleaning process is over, the control system controls the liquid waste to flow into the liquid waste disposal device and discharge it.

15. The method according to claim 13, further comprising:
in the working stage of the spray system, proving the spray liquid to the spray heads of the final spray member by the control system controlling the spray liquid supply system, the spray liquid flows into the spray liquid circulatory tank below the final spray member, flows into the spray heads of the last spray member through the spray liquid inlet pipe under the action of the power member, which is recycled, and flows into the spray heads of the first spray member; and
after the spraying process is over, the control system controls the spray liquid to flow into the spray liquid recovery device and discharge it.
